(19) United States
(12) Patent Application Publication
(10) Pub. No.: US 2017/0374310 A1
(43) Pub. Date: Dec. 28, 2017

(54) DISPLAY APPARATUS, DISPLAY METHOD, STORAGE MEDIUM AND DISPLAY SYSTEM

(71) Applicant: Casio Computer Co., Ltd., Tokyo (JP)

(72) Inventor: Kazunori Yanagi, Tokyo (JP)

(21) Appl. No.: 15/498,712

(22) Filed: Apr. 27, 2017

(30) Foreign Application Priority Data
Jun. 27, 2016 (JP) 2016-126837
Feb. 6, 2017 (JP) 2017-019939

(51) Int. Cl. H04N 5/445

(52) U.S. Cl. CPC H04N 5/44504

(57) ABSTRACT

A display apparatus acquires positional information regarding imaging points where images have been manually or automatically captured while the user is moving and predetermined information regarding the capturing of the images from a digital camera and a sensor apparatus by wireless communication, and displays indices of the predetermined information on points indicated by the positional information on a map displayed on a display section.

### CROSS-REFERENCE TO RELATED APPLICATIONS

This application is based upon and claims the benefit of priority from the prior Japanese Patent Application No. 2016-126837, filed Jun. 27, 2016 and Japanese Patent Application No. 2017-019939, filed Feb. 6, 2017, the entire contents of which are incorporated herein by reference.

### BACKGROUND OF THE INVENTION

### 1. Field of the Invention

The present invention relates to a technology for grasping imaging situations.

### 2. Description of the Related Art

Conventionally, a technique has been conceived in which positional information of a user performing image capturing is acquired by use of GPS (Global Positioning System) or the like and, when an image captured therein is to be replayed, a map of the surrounding area including the imaging location indicated by the positional information is displayed such that an index indicating the image capturing is displayed on the imaging location on this map, as shown in Japanese Patent Application Laid-Open (Kokai) Publication No. 2006-279266.

### SUMMARY OF THE INVENTION

In accordance with one aspect of the present invention, there is provided a display apparatus comprising: a positional information acquisition section which acquires positional information regarding capturing of an image; an imaging information acquisition section which acquires predetermined information regarding the capturing of the image; a generation section which generates an index image based on the predetermined information acquired by the imaging information acquisition section; and a display section which displays the index image generated by the generation section at a position indicated by the positional information acquired by the positional information acquisition section.

In accordance with another aspect of the present invention, there is provided a display method comprising: a positional information acquisition step of acquiring positional information regarding capturing of an image; an imaging information acquisition step of acquiring predetermined information regarding the capturing of the image; a generation step of generating an index image based on the predetermined information acquired in the imaging information acquisition step; and a display step of displaying the index image generated in the generation step at a position indicated by the positional information acquired in the positional information acquisition step.

In accordance with another aspect of the present invention, there is provided a non-transitory computer-readable storage medium having stored thereon a program that is executable by a computer to actualize functions comprising: positional information acquisition processing for acquiring positional information regarding capturing of an image; imaging information acquisition processing for acquiring predetermined information regarding the capturing of the image; generation processing for generating an index image based on the predetermined information acquired in the imaging information acquisition processing; and display processing for displaying the index image generated in the generation processing at a position indicated by the positional information acquired in the positional information acquisition processing.

In accordance with another aspect of the present invention, there is provided a display system comprising: a display apparatus; a positional information recording apparatus which sequentially records positional information of a moving person; and an imaging apparatus which is carried by the person, wherein the display apparatus comprises: a positional information acquisition section which acquires the positional information from the positional information recording apparatus; an imaging information acquisition section which acquires, from the imaging apparatus, predetermined information regarding capturing of an image recorded in the imaging apparatus; a generation section which generates an index image based on the predetermined information acquired by the imaging information acquisition section; and a display control section which controls to display the index image generated by the generation section at a position indicated by the positional information acquired by the positional information acquisition section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the configuration of a display system including a display apparatus according to a first embodiment of the present invention;

FIG. 2 is a flowchart showing operations in a sensor apparatus and a camera apparatus when their user is moving;

FIG. 3 is an explanatory view showing a relation between trigger output conditions of the sensor apparatus and imaging (or sound recording) modes of the camera apparatus;

FIG. 4 is a flowchart showing operations in the display apparatus when an image processing program is activated, and the corresponding operations in the camera apparatus;

FIG. 5 is a flowchart following that of FIG. 4;

FIG. 6 is a flowchart showing operations in the sensor apparatus corresponding to those of FIG. 4;

FIG. 7 is a conceptual diagram describing a log table that is stored in a storage section when the image processing program is running;

FIG. 8 is a diagram showing a display style of a user's action history and recording information of images and the like, in the display apparatus;

FIG. 9 is a diagram showing the contents of a data processing condition table in a second embodiment;

FIG. 10 is a conceptual diagram describing a log table that is stored in a storage section in the second embodiment;

FIG. 11 is a flowchart showing operations in a display apparatus when an image processing program is activated in the second embodiment;

FIG. 12 is a flowchart following that of FIG. 11;

FIG. 13 is a diagram showing a display style of front cover data in the display apparatus in the second embodiment;

FIG. 14A is a diagram showing a top view display style of a user's action history and recording information of images and the like, in the display apparatus of the second embodiment;

FIG. 14B is a diagram showing a bird view display style of the user's action history and the recording information of images and the like, in the display apparatus of the second embodiment; and

FIG. 14C is a diagram showing a side view display style of the user's action history and the recording information of images and the like, in the display apparatus of the second embodiment.

### DETAILED DESCRIPTION OF THE PREFERRED EMBODIMENTS

### First Embodiment

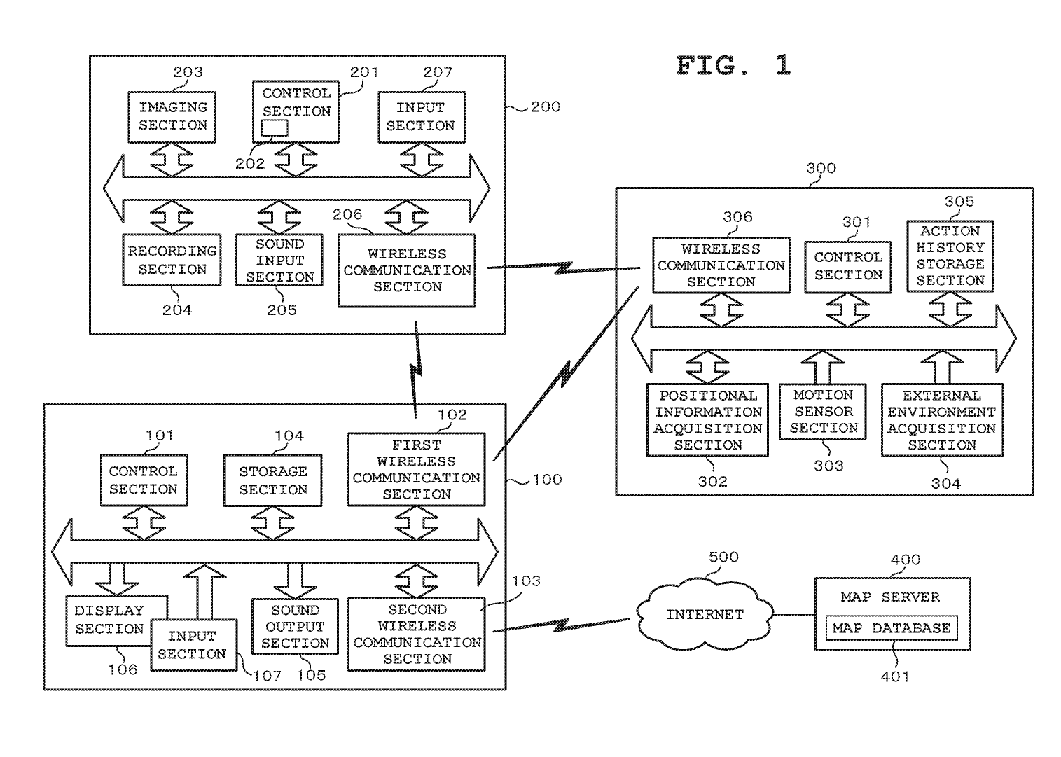

A first embodiment of the present invention will hereinafter be described. FIG. 1 is a block diagram showing the configuration of a display system including a display apparatus 100 according to the first embodiment of the present invention. This display system is constituted by the display apparatus 100, a camera apparatus 200, and a sensor apparatus 300 which are communicable with one another.

First, the camera apparatus 200 is described. This camera apparatus 200, which is a compact digital camera capable of performing still image capturing, moving image capturing, and sound recording with it being worn on a user's body, includes a control section 201 that controls the entire operation of the apparatus, an imaging section 203, a recording section 204, a sound input section 205, a wireless communication section 206, and an input section 207.

The control section 201 is constituted by a CPU (Central Processing Unit), its peripheral circuits, a working memory such as a RAM (Random Access memory), a program memory, and the like, and controls each section of the camera apparatus 200 by operating in accordance with a program stored in the program memory. Note that this control section 201 includes clocking means having a calendar function for acquiring imaging (or sound recording) dates and times.

The imaging section 203 is constituted by an image sensor such as a CMOS (Complementary Metal Oxide Semiconductor) or a CCD (Charge Coupled Device) which captures a photographic subject via an imaging optical system not shown, its drive circuit, a signal processing circuit for converting an analog signal outputted from the image sensor into image data in a digital format, and the like, and provides this image data to the control section 201. Note that the imaging optical system of the camera apparatus 200 is constituted by one or a plurality of wide angle lenses capable of capturing a whole-sky image showing a 360-degree view of surrounding areas.

The above-described image data provided to the control section 201 is subjected to various types of image processing, and then compressed. Subsequently, various pieces of additional information regarding its imaging data and time, its thumbnail image, and the like are added to it. Then, this data is recorded in the recording section 204 as a still image file or a moving image file in a predetermined format. The recording section 204 is constituted by, for example, a rewritable non-volatile memory such as a flash memory mounted in the camera apparatus 200 or a memory card that can be attached to and detached from the apparatus.

This camera apparatus 200 has, as subsidiary modes for its still image capturing mode, plural types of imaging modes including a portrait imaging mode, a scenery imaging mode, a consecutive imaging mode for consecutively performing image capturing a plurality of times, and a whole-sky imaging mode for capturing a 360-degree view of surrounding areas. Also, this camera apparatus 200 has, as subsidiary modes for its moving image capturing mode, plural types of imaging modes including a normal moving image capturing mode and a short (for example, 10 seconds) moving image capturing mode. When image data is to be recorded in the recording section 204 as a still image file or a moving image file, additional information regarding an image capturing mode used for the image capturing and the imaging date and time are added to this file.

The sound input section 205, which is constituted by a microphone provided in the apparatus body, an amplifier, and an A/D (Analog-to-Digital) converter, converts ambient sound inputted via the microphone into sound data, and provides it to the control section 201. The sound data provided to the control section 201 is coded therein and, in the case of moving image capturing, added to moving image data so as to be recorded as a moving image file.

This camera apparatus 200 has, as an operation mode, a recording mode for recording only sound. In this recoding mode, additional information regarding a recording date and time and the like is added to sound data coded in the sound input section 205, and the sound data is recorded in the recording section 204 as an independent sound file. Note that a method may be adopted in which coded sound data in moving image capturing is recorded in association with moving image data instead of being added thereto.

The wireless communication section 206 performs wireless communication with the display apparatus 100 and the sensor apparatus 300. In particular, the wireless communication section 206 transmits a still image file, a moving image file, or a sound file recorded in the recording section 204 to the display apparatus 100 as necessary.

As the wireless communication technology for the wireless communication section 206, for example, Wi-Fi (Wireless Fidelity: registered trademark) technology that applies the International Standard IEEE-802.11 series or Bluetooth (registered trademark) technology is adopted. However, as long as communication with the display apparatus 100 and the sensor apparatus 300 can be performed, any communication technology can be adopted for the wireless communication section 206 regardless of whether it is wireless communication means or wired communication means.

The input section 207 is constituted by a mode setting switch, a shutter button, and the like, and provides the user's operation information to the control section 101.

Next, the sensor apparatus 300 is described. This sensor apparatus, which is used by being worn on a body part of the user such as a shoulder, an arm, or the waist, is what is called a data logger that sequentially acquires the later-described various data regarding the user's action history and records them.

As shown in the drawing, the sensor apparatus 300 includes a control section 301 that controls the entire operation of the apparatus, a positional information acquisition section 302, a motion sensor section 303, an external environment acquisition section 304, an action history storage section 305, and a wireless communication section 306.

The control section 301 is constituted by a CPU, its peripheral circuits, a working memory such as a RAM, a program memory, and the like, and controls each section of the sensor apparatus 300 by operating in accordance with a program stored in the program memory.

The positional information acquisition section 302 calculates a current position by using well-known GPS (Global Positioning System), and provides the control section 301 with GPS data regarding latitude, longitude, and altitude which is the result of the calculation.

The motion sensor section 303 includes an acceleration sensor that detects accelerations in three axis directions, a gyro sensor that detects angular velocities in three axis directions, an amplifier that amplifies a detection signal, and an A/D converter. This motion sensor section 303 provides the information of accelerations and angular velocities in three axis directions to the control section 301.

The external environment acquisition section 304 includes a temperature sensor, an atmospheric pressure sensor, and a moisture sensor which detect temperature, atmospheric pressure, and humidity around the sensor apparatus 300, respectively. Also, the external environment acquisition section 304 includes an amplifier that amplifies detection signals from each sensor, and an A/D converter. Data (hereinafter referred to as external environment data) regarding the detected temperature, atmospheric pressure, and humidity is provided to the control section 301.

The action history storage section 305 is constituted by a rewritable non-volatile memory such as a flash memory mounted in the camera apparatus 200, and stores action history data including GPS data and external environment data provided to the control section 301. Note that this action history data also includes data regarding the number of steps of the user counted by the control section 301 based on acceleration information and angular velocity information acquired by the motion sensor section 303.

The wireless communication section 306 performs wireless communication with the display apparatus 100 and the camera apparatus 200. In particular, the wireless communication section 306 transmits action history data (GPS data and external environment data) stored in the action history storage section 305 to the display apparatus 100. As the wireless communication technology for the wireless communication section 306, Wi-Fi (Wireless Fidelity: registered trademark) technology that applies the International Standard IEEE-802.11 series or Bluetooth (registered trademark) technology is adopted. However, as long as communication with the display apparatus 100 and the camera apparatus 200 can be performed, any communication technology can be adopted for the wireless communication section 306 regardless of whether it is wireless communication means or wired communication means.

Next, the display apparatus 100 is described. This display apparatus 100 has a function for displaying a map where the user's movement route has been superimposed based on GPS data acquired from the sensor apparatus 300, a function for displaying a still image based on a still image file acquired from the camera apparatus 200, and a function for replaying and displaying a moving image based on a moving image file.

As shown in the drawing, the display apparatus 100 includes a control section 101 that controls each section of the apparatus, a first wireless communication section 102, a second wireless communication section 103, a storage section 104, a sound output section 105, a display section 106, and an input section 107.

The control section 101 is constituted by a CPU, its peripheral circuits, a working memory such as a RAM, and the like, and controls each section of the display apparatus 100 by operating in accordance with a program stored in the storage section 104.

The first wireless communication section 102 performs wireless communication with the camera apparatus 200 and the sensor apparatus 300. In particular, the first wireless communication section 102 receives the above-described action history data from the sensor apparatus 300, and receives the above-described still image file, moving image file, and sound file from the camera apparatus 200. As the wireless communication technology for the first wireless communication section 102, Wi-Fi (Wireless Fidelity: registered trademark) technology that applies the International Standard IEEE-802.11 series or Bluetooth (registered trademark) technology is adopted. However, as long as communication with the camera apparatus 200 and the sensor apparatus 300 can be performed, any communication technology can be adopted for the first wireless communication section 102 regardless of whether it is wireless communication means or wired communication means.

The second wireless communication section 103 performs TCP/IP (Transmission Control Protocol/Internet Protocol) based communication with an external map server 400 having a map database 401, and receives map data of a predetermined area stored in the map database 401 via the Internet 500. Note that the connection with the Internet 500 by the second wireless communication section 103 is performed via, for example, a wireless base station for a commercial communication network (mobile phone lines) or a wireless base station for a public LAN (Local Area Network).

The storage section 104 is constituted by a rewritable non-volatile memory such as a flash memory mounted in the display apparatus 100, and stores a base program required for controlling the operation of the display apparatus 100 and various types of application programs. The various types of application programs herein include an image processing program for processing a still image file or a moving image file recorded in the camera apparatus 200 in association with a movement route of the user wearing the camera apparatus 200 and the sensor apparatus 300, and an activity analysis program.

The storage section 104 temporarily stores various data received from the sensor apparatus 300 and the camera apparatus 200. Also, in this storage section 104, the later-described various data are stored by the control section 101. Moreover, the later-described log table 1041 is stored in this storage section 104.

The sound output section 105 is constituted by a D/A (Digital-to-Analog) converter that converts sound data in a sound file into an analog sound signal, an amplifier, a loudspeaker, and the like, and replays sound data received from the camera apparatus 200.

The display section 106, which is constituted by a liquid crystal panel and its drive circuit, displays an operation screen for operating the display apparatus 100, the later-described surrounding area map, a still or moving image received from the camera apparatus 200, etc.

The input section 107 is constituted by operation buttons for the user to operate the display apparatus 100 and a touch panel integrally provided on the surface of the liquid crystal panel of the display section 106, and provides information regarding the user's operation to the control section 101.

Note that the above-described display apparatus 100 can be actualized by, for example, a smartphone or a tablet-type portable information apparatus and, in this case, includes known circuits for performing voice communication and data communication, such as a voice input circuit and a transmission circuit for modulating and transmitting an inputted voice, a reception circuit and a playback circuit for receiving, decoding, and replaying a voice signal, and a data transmission and reception circuit.

In the display system including the above-described apparatuses, for example, when a user who is climbing a mountain or hiking wears the camera apparatus 200 and the sensor apparatus 300, activates them, and performs a predetermined operation so that they can communicate with each other, the camera apparatus 200 and the sensor apparatus 300 operate as described below. Note that the camera apparatus 200 herein has a predetermined operation mode (hereinafter referred to as “collaborative operation mode”) in which, when interval photographing is being performed at predetermined time intervals, automatic image capturing or automatic sound recording is performed in response to a request from the sensor apparatus 300. When this mode is set, communication with the sensor apparatus 300 is established.

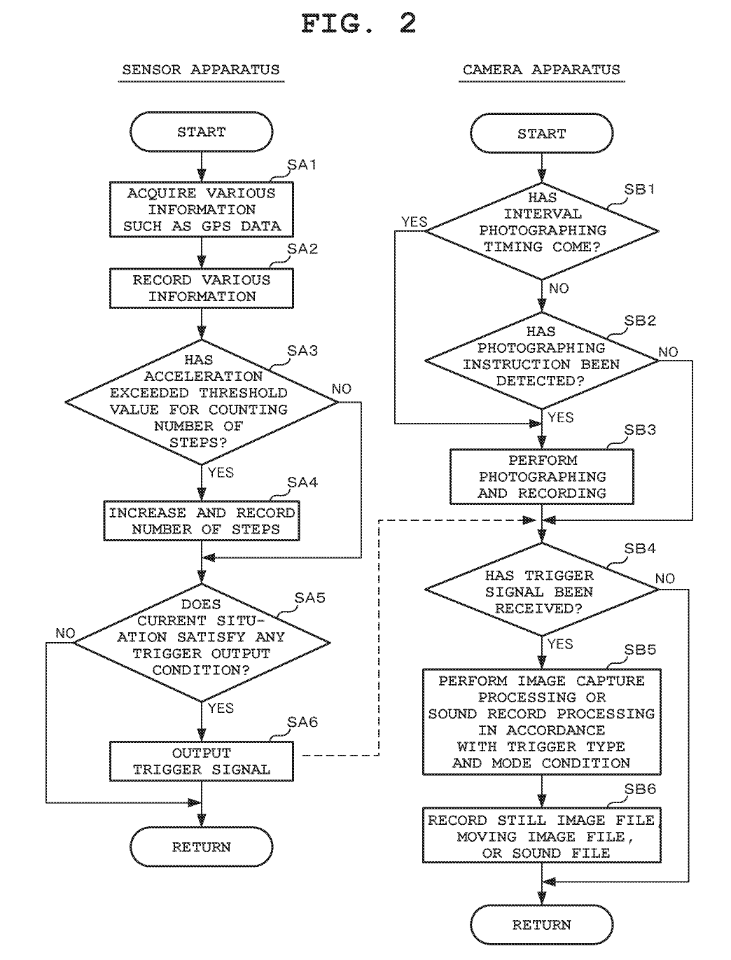

FIG. 2 is a flowchart showing operations in the camera apparatus 200 based on processing by the control section 201 and operations in the sensor apparatus 300 based on processing by the control section 301 in the collaborative operation mode.

First, the operations in the sensor apparatus 300 are described. The sensor apparatus 300 starts operating by detecting power-on, and acquires various information such as GPS data by the positional information acquisition section 302, the motion sensor section 303, and the external environment acquisition section 304 (Step SA1). Subsequently, the sensor apparatus 300 records the acquired various information as action history data (Step SA2). Note that a configuration may be adopted in which, when power-on is detected, the establishment of communication between the sensor apparatus 300 and the camera apparatus 200 is performed as background processing.

Then, when acceleration information among the acquired various information is exceeding a predetermined threshold value and angular velocity information therein is satisfying a predetermined condition (YES at Step SA3), the sensor apparatus 300 records the exceeding acceleration information as one step of the user and adds it to the user's total steps (Step SA4). Note that number-of-steps data generated after this addition is recorded together with other action history data recorded at the immediately preceding processing of Step SA2, as one record.

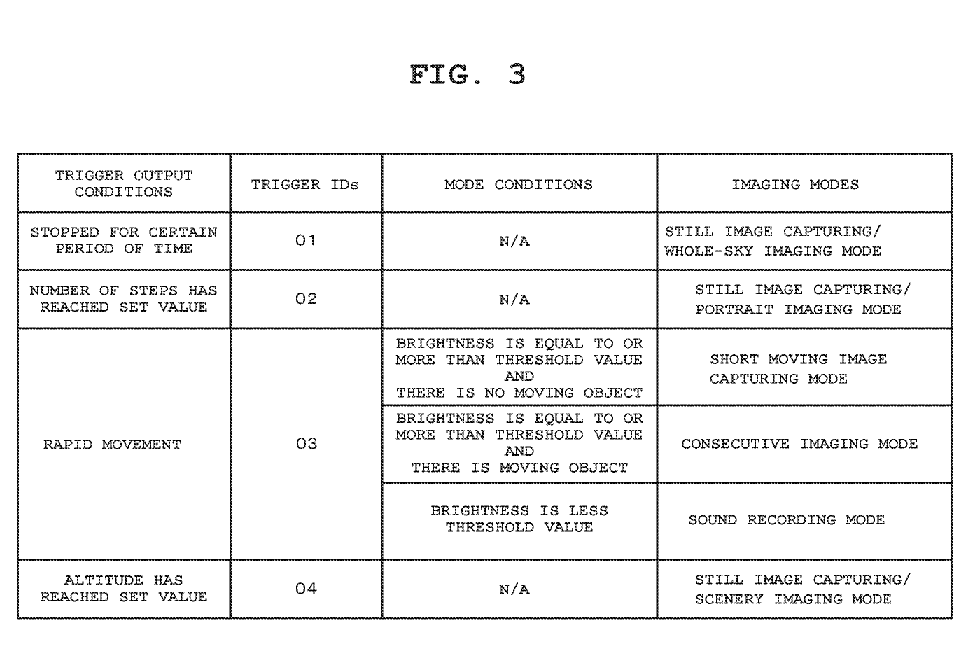

On the other hand, the sensor apparatus 300 sequentially judges whether a current situation satisfies any predetermined trigger output condition (imaging control condition) (Step SA5). The trigger output conditions herein are four types of conditions defined by the number of steps, acceleration information, angular velocity information, and GPS data, which are shown in FIG. 3.

That is, the four conditions are a condition that a current position indicated by GPS data has not changed for a certain period of time (“STOPPED FOR CERTAIN PERIOD OF TIME” in FIG. 3); a condition that the number of steps has reached a set value (“NUMBER OF STEPS HAS REACHED SET VALUE” in FIG. 3); a condition that an acceleration value has changed and exceeded the range of acceleration changes occurred within a latest certain period of time and its change amount has exceeded a threshold value by which whether or not the user has moved rapidly can be judged (“RAPID MOVEMENT” in FIG. 3); and a condition that the altitude of a current position indicated by GPS data has reached a set value (“ALTITUDE HAS REACHED SET VALUE” in FIG. 3).

Then, when judged that the current situation does not satisfy any predetermined trigger output condition (NO at Step SA5), the sensor apparatus 300 immediately returns to the processing of Step SA1, and repeats this processing and the following processing.

Conversely, when judged that the current situation satisfies one of the predetermined trigger output conditions (YES at Step SA5), the sensor apparatus 300 outputs, by wireless communication, a predetermined trigger signal for requesting the camera apparatus 200 to perform image capturing (Step SA6). This predetermined trigger signal is a signal having a trigger ID (“01”, “02”, “03”, or “04”) indicating a trigger output condition judged to have been satisfied. Then, the sensor apparatus 300 returns to the processing of Step SA1, and repeats this processing and the following processing.

That is, the sensor unit 300 outputs a trigger signal to the camera apparatus 200 every time a situation satisfying a predetermined trigger output condition occurs while performing the processing of sequentially acquiring various information such as GPS data, counting the number of steps, and recording them.

On the other hand, after starting to operate by the collaborative operation mode being set, the camera apparatus 200 repeats an operation of counting down an interval time for acquiring photographing timing for interval photographing (not shown). Then, every time photographing timing for interval photographing comes (YES at Step SB1), the camera apparatus 200 automatically performs still image capturing, and records a still image file acquired thereby in the recording section 204 (Step SB3). In the recording of this still image file, information regarding its recording operation type which indicates whether it has been recorded automatically or manually (automatic recording by interval photographing in this case) is added to the still image file together with other additional information regarding an imaging mode used for the image capturing and the imaging date and time.

Also, even when photographing timing has not come (NO at Step SB1), if the user's photographing instruction is detected (YES at Step SB2), the camera apparatus 200 performs image capturing and records a still image file or a moving image file (Step SB3). Note that the image capturing in response to the user's photographing instruction herein is still image capturing or moving image capturing in an arbitrary imaging mode set in advance by the user. Also, in the still image file or the moving image file herein, information regarding its recording operation type (manual recording in this case) is added together with other additional information regarding an imaging mode used for the image capturing and the imaging date and time.

Then, when the above-described trigger signal is received from the sensor apparatus 300 (YES at Step SB4), the camera apparatus 200 performs image capture processing or sound record processing in accordance with the type of a trigger indicated by the trigger ID and a predetermined mode condition (Step SB5).

More specifically, still image capture processing in the whole-sky imaging mode is performed when the trigger ID is “01”, still image capture processing in the portrait imaging mode is performed when the trigger ID is “02”, and still image capture processing in the scenery imaging mode is performed when the trigger ID is “04”, as shown in FIG. 3.

Also, when the trigger ID is “03”, a recording operation in accordance with a mode condition at that point is performed. That is, when the brightness at that point is equal to or more than a threshold value and there is no moving object in the viewing angle, moving image capture processing for a short video is performed. When the brightness at that point is equal to or more than the threshold value and there is a moving object in the viewing angle, still image capture processing in the consecutive imaging mode is performed. When the brightness at that point is less than the threshold value, sound record processing is performed. Note that the brightness at that point in the processing of Step SB5 is detected from an image captured by the imaging section 203, and whether or not there is a moving object in the viewing angle is judged using an image having a plurality of frames acquired by the imaging section 203.

Then, the camera apparatus 200 records, in the recording section 204, a still image file, a moving image file, or a sound file acquired by the image capture processing or the sound record processing performed at Step SB5 (Step SB6). Here, in the still image file or the moving image file, information regarding its recording operation type (which is, in this case, automatic image capturing in response to a trigger signal) is added together with other additional information regarding an imaging mode used in the image capturing, the imaging date and time, and the like. Also, in the sound file, information regarding its recording operation type (which is, in this case, automatic sound recording in response to a trigger signal) is added together with other additional information regarding the sound recoding date and time and the like. Hereafter, the camera apparatus 200 returns to the processing of Step SB1, and repeats this processing and the processing of the following steps.

Next, operations in the display apparatus 100 are described. With this display apparatus 100, a movement route of the user wearing the camera apparatus 200 and the sensor apparatus 300 and arbitrary captured images and the like recorded in the camera apparatus 200 can be checked by the user using the image processing program.

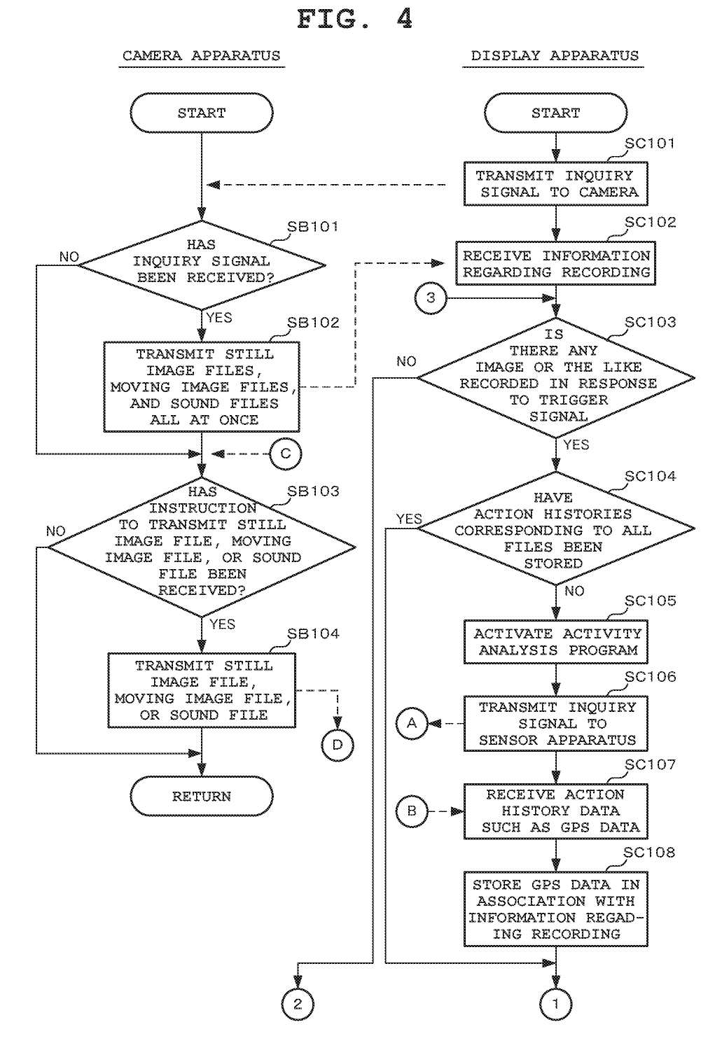

FIG. 4 to FIG. 6 are flowcharts showing operations in the display apparatus 100 when the image processing program is activated by the user, and operations in the camera apparatus 200 and the sensor apparatus 300 corresponding to the operations in the display apparatus 100. More specifically, FIG. 4 to FIG. 6 are diagrams showing processing by each control section 101, 201, and 301 in the display apparatus 100, the camera apparatus 200, and the sensor apparatus 300.

As shown in FIG. 4, when the image processing program is activated, the display apparatus 100 first transmits to the camera apparatus 200 an inquiry signal for requesting to transmit information regarding the recording of still image files, moving image files, and sound files (Step SC101). When this inquiry signal is received (YES at Step SB101), the camera apparatus 200 transmits information regarding the recording of still image files, moving image files, and sound files stored in the recording section 204 all at once (Step SB102). Note that the information regarding the recording herein is, in the cases of the still image files and the moving image files, their file names, imaging dates and times, imaging modes, and recording operation types. In the case of the sound files, the information regarding the recording is their file names, recording dates and times, and recording operation types (automatic operation or manual operation).

Then, after receiving and storing the information regarding the recording from the camera apparatus 200 (Step SC102), the display apparatus 100 checks the recording operation type of each file, and judges whether or not there is any image or the like recorded by a trigger signal from the sensor apparatus 300 being received (Step SC103).

When judged that there are images or the like recorded by trigger signals being received (YES at Step SC103), the display apparatus 100 judges whether action histories corresponding to all the files including these images or the like have been stored and, when judged that they have not been stored (NO at Step SC104), activates the activity analysis program (Step SC105). This activity analysis program is to acquire action history data (GPS data, external environment data, and number-of-steps data) recorded in the sensor apparatus 300 and analyze the user's activity when he or she is wearing the sensor apparatus 300 based on the acquired action history data.

Then, by using a part of a function actualized by processing performed by the control section 101 in accordance with this activity analysis program, the display apparatus 100 transmits to the sensor apparatus 300 an inquiry signal for requesting to transmit action history data including GPS data (Step SC106). Note that, although the action history data herein for which the transmission request has been made to the sensor apparatus 300 are data recorded at the time of the recording of each file, a different configuration may be adopted in which only the data of one or a plurality of specific records corresponding to the images or the like recorded in response to the trigger signals are requested.

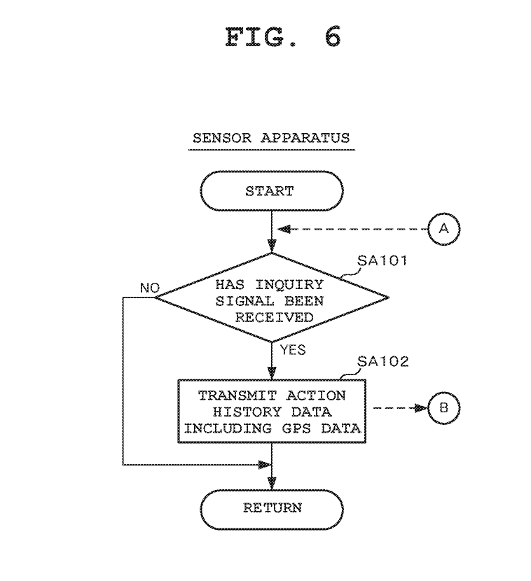

Subsequently, when the inquiry signal is received (YES at Step SA101), the sensor apparatus 300 transmits the action history data (the requested record data) stored in the action history storage section 305 to the display apparatus 100, as shown in FIG. 6 (Step SA102).

Then, after receiving the action history data from the sensor apparatus 300 (Step SC107), the display apparatus 100 associates the imaging or sound recording date and time of each file with GPS data acquired on the same date and time and included in the received action history data, and stores them in the log table 1041 of the storage section 104 (Step SC108).

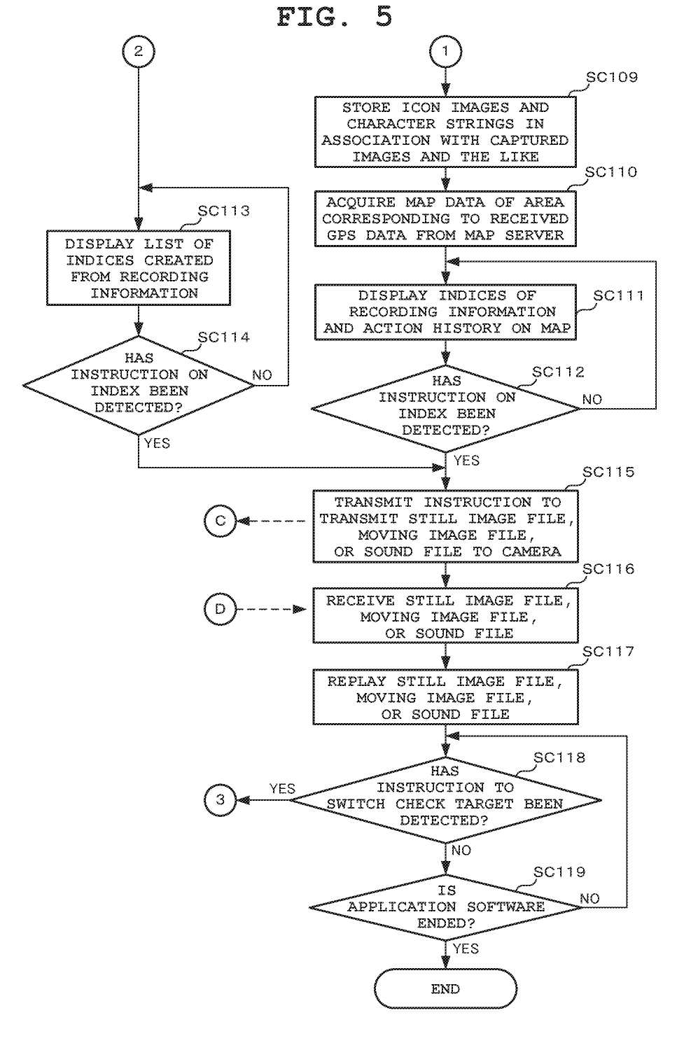

Next, the display apparatus 100 stores icon images and character strings in the storage section 104 in association with the information regarding the recording of the still image files, the moving image files, and the sound files, as shown in FIG. 5 (Step SC109). The icon images herein are images prepared in advance for the image processing program, and each of which corresponds to a mode of the camera apparatus 200 at the time of the recording of an image or the like. More specifically, icon images each representing an imaging mode at the time of recording are provided for still image files and moving image files, and an icon image representing a sound recording operation is provided for sound files. Note that these icon images are not necessarily required to be prepared in advance and a configuration may be adopted in which a mode at the time of recording is identified based on profile data of a still image file, a moving image file, or a sound file, and an icon image suitable therefor is generated. The above-described character strings are character strings generated based on modes used at the time of the recording of images or the like by trigger signals, or on trigger output conditions (refer to FIG. 3) indicated by trigger IDs included in the images or the like.

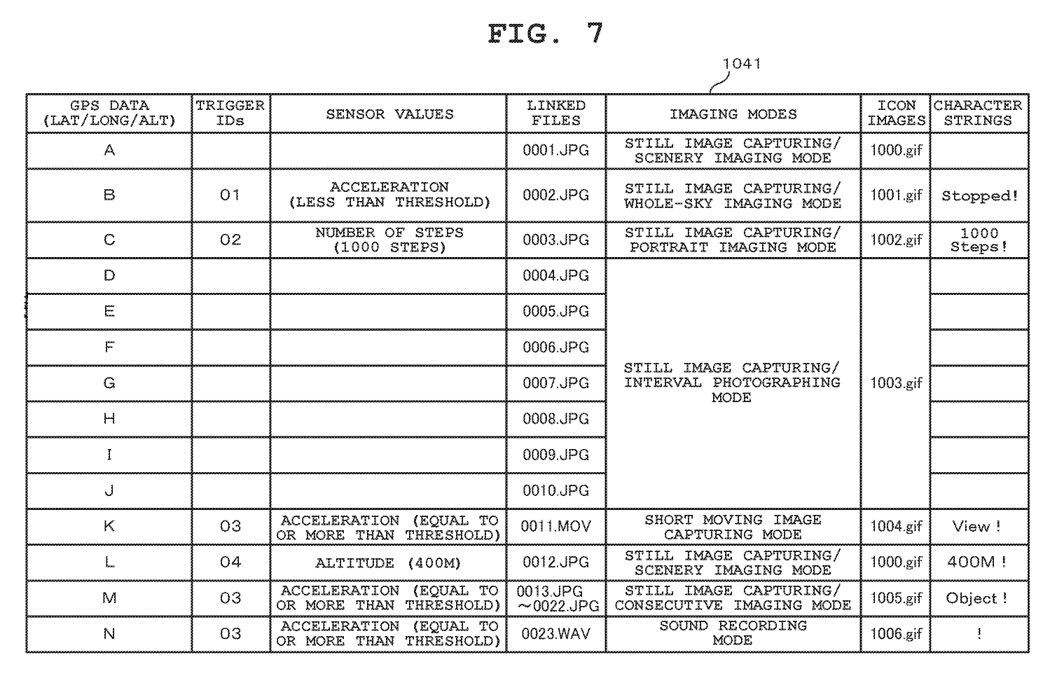

FIG. 7 is a diagram showing an example of the memory contents of the log table 1041 stored in the storage section 104 by the above-described processing. In this diagram, examples of information stored in association with images and the like (the file names of linked still image files, moving image files, and sound files), GPS data, icon images (their file names), character strings are, for descriptive purposes, shown with imaging (or sound recording) modes based on which the icon images have been determined, trigger IDs used to determine the character strings together with these modes, and sensor values (including the number of steps) at the time of the recording of the images and the like. Note that, in the GPS data in the drawing, specific points “A” to “N” are shown for descriptive purposes.

Here, the character strings to be stored in the storage section 104 by the processing of Step SC109 are described using this example. In the case of record data corresponding to trigger ID “01”, acceleration indicated by its sensor value is less than a threshold value, at point “B” indicated by its GPS data. Accordingly, there is a high possibility that the user has stopped at this point from which the GPS data has been transmitted. Therefore, the character string “Stopped!” is stored.

In the case of record data corresponding to trigger ID “02”, its number-of-steps data indicates 1000 steps, at point “C” indicated by its GPS data. Therefore, the character string “1000 Steps!” is stored.

In the case of record data corresponding to trigger ID “03”, acceleration indicated by its sensor value is more than the threshold value, at point “K” indicated by its GPS data. Accordingly, a judgment is made that a state where the user is viewing something has occurred, and therefore the character string “View!” is stored.

In the case of record data corresponding to trigger ID “04”, an altitude of 400 meters has been recorded as its sensor value (altitude data) transmitted from the sensor apparatus 300, at point “L” indicated by its GPS data. Accordingly, the character string “400 M!” is stored.

Then, at Step SC110, the display apparatus 100 is connected to the external map server 400, and acquires, from the map server 400, map data of an area including points acquired by GPS and corresponding to the plurality of GPS data in the action history data acquired by the processing of Step SC107 (Step SC110).

Next, the display apparatus 100 displays, on the display section 106, a map that is based on the map data acquired from the map server 400 and showing the area including the recording points (imaging points and sound recording points) where the still image files, the moving image files, and the sound files have been recorded, and displays the user's action history (movement route) on the map, so that display of contents such as those registered in FIG. 7 is performed (Step SC111).

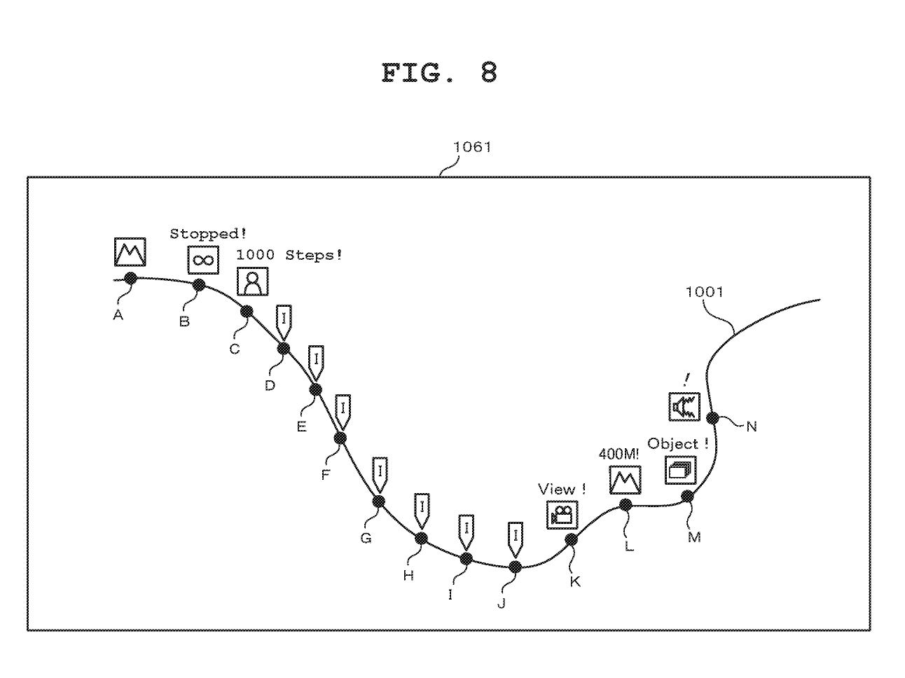

FIG. 8 is a diagram showing an example where the icon images of the still image files, the moving image files, and the sound file shown in the example in FIG. 7, and the character strings have been displayed on the display section 106 in association with their GPS data.

The above-described display is explained using this example of FIG. 8. In the processing of Step SC110, the display apparatus 100 draws the user's movement route 1001 on the map displayed on the display section 106 based on the GPS data in the action history data acquired by the processing of Step SC107. Then, the display apparatus 100 displays, on the movement route 1001, points A to N (black circles in the drawing) where the still image files, the moving image files, and the sound file have been recorded.

In addition, the display apparatus 100 displays, on areas near points A to N, the icon images (indices) corresponding to the modes used at the time of the recording of the images and the like at these points, as information regarding the recording of these images and the like. That is, the display apparatus 100 displays icon images corresponding to the imaging modes (including the interval photographing mode) for the captured images (the still image files and the moving image files), and displays an icon image corresponding to the sound recording mode for the sound data (the sound file). Moreover, on areas near points B, C, and K to N, the display apparatus 100 displays the character strings (such as “Stopped!”) with the icon images.

Then, at Step SC112, when it is detected that one of the indices (icon images) has been pointed (touched) while contents such as that shown in FIG. 8 are being displayed (Step SC112), the display apparatus 100 transmits to the camera apparatus 200 a transmission instruction signal for instructing to transmit an image or the like corresponding to the touched index, such as a still image file, a moving image file, or a sound file (Step SC115).

When the transmission instruction signal is received (YES at Step SB103), the camera apparatus 200 reads out from the recording section 204 a still image file, a moving image file, or a sound file for which the transmission instruction has been given, and transmits it to the display apparatus 100, as shown in FIG. 4 (Step SB104).

After receiving this file from the camera apparatus 200 (Step SC116), the display apparatus 100 replays a still image, a moving image, or a sound included in the received file (Step SC117).

Then, the display apparatus 100 judges whether an instruction to switch the check target has been given by the user, and whether an instruction to end the image processing program has been given by the user (Step SC118 and Step SC119). When judged that an instruction to switch the check target has been given by the user (YES at Step SC118), the display apparatus 100 returns to the processing of Step SC103 in FIG. 4, repeats the processing of the following steps, and displays the map, the action history, and the like on the display section 106. Here, although omitted in the drawing, if the captured still image or moving image is still being displayed when the instruction to switch the check target is given, the display thereof is ended.

At Step SC119, when an instruction to end the image processing program has been given by the user, the display apparatus 100 ends all processing operations related to the image processing program (YES at Step SC119).

At Step SC103 in FIG. 4, when the judgment result is “NO”, that is, when the information regarding the recording which has been transmitted from the camera apparatus 200 does not include any image or the like recorded by a trigger signal from the sensor apparatus 300 being received, the display apparatus 100 performs the processing described below which is different from the above-described processing.

That is, the display apparatus 100 displays on the screen of the display section 106 a list of indices (icon images) created from the information regarding the recording of each file, as shown in FIG. 5 (Step SC113). That is, the display apparatus 100 performs the list display of icon images corresponding to modes used at the time of the recording of each file.

Then, when it is detected that one of the indices (icon images) on the screen has been pointed (touched) by the user (YES at Step SC114), the display apparatus 100 transmits to the camera apparatus 200 a transmission instruction signal for instructing to transmit a still image files, a moving image file, or a sound file corresponding to the touched index (Step SC115).

In this case as well, when the transmission instruction signal is received (YES at Step SB103), the camera apparatus 200 reads out from the recording section 204 a still image file, a moving image file, or a sound file for which the instruction has been given, and transmits it to the display apparatus 100, as shown in FIG. 4 (Step SB104).

After receiving the still image file, the moving image file, or the sound file from the camera apparatus 200 (Step SC116), the display apparatus 100 replays a still image, a moving image, or a sound included in the received file (Step SC117). Then, the display apparatus 100 performs the above-described processing. That is, when the user's instruction to switch the check target is detected (YES at Step SC118), the display apparatus 100 returns to the processing of Step SC103 in FIG. 4, and repeats the processing of the following steps. In this case as well, if the captured still image or moving image is still being displayed when the instruction to switch the check target is given, the display thereof is ended.

Then, the display apparatus 100 displays again the list of the indices created from the information regarding the recording, on the screen of the display section 106 (Step SC113). Here, when an instruction to end the image processing program is given by the user (YES at Step SC119), the display apparatus 100 ends all the processing operations related to the image processing program.

As described above, the display apparatus 100 not only displays imaging points and sound recording points on a map showing the user's movement route but also displays, near the imaging points and the sound recording points, icon images indicating modes used at the time of the image capturing and the sound recording. As a result of this configuration, the user can easily grasp imaging and sound recording situations, such as modes used at imaging and sound recording points on a movement route, triggers (reasons) for the image capturing and sound recording at the imaging and sound recording points, and the purposes of the image capturing and sound recording. This configuration is especially effective when several days have passed since an imaging and sound recording date or when the user checks imaging and sound recording situations at points where imaging and sound recording operations have been performed not manually but automatically.

Accordingly, for example, even when a number of images have been captured (there is a number of imaging points) or several days have passed since an imaging date, images automatically captured in specific situations can be easily grasped.

Also, when an icon image is pointed from among icon images displayed on imaging points, a captured image (original image) corresponding thereto is displayed. As a result of this configuration, the user can easily perform an operation where only an image automatically captured in a specific situation is replayed so as to check its contents.

Moreover, on imaging points on a map where automatic imaging operations have been performed, character strings can be displayed in addition to icon images. Therefore, the user's action contents (predetermined action contents) at the time of the imaging operations can be checked. As a result of this configuration, an imaging situation at each imaging point can be more easily grasped.

Furthermore, the display apparatus 100 wirelessly acquires imaging modes used for capturing images from the camera apparatus 200, and wirelessly acquires GPS data regarding the imaging points of the captured images. As a result of this configuration, the user of the display apparatus 100 can easily check an imaging situation at each imaging point on a movement route.

Still further, in a case where another user different from the user of the display apparatus 100 is using the camera apparatus 200 and the sensor apparatus 300, the user of the display apparatus 100 can easily check the other user's imaging situation.

In the present embodiment, the display system has been mainly described which is constituted by the display apparatus 100, the camera apparatus 200, and the sensor apparatus 300. However, a configuration may be adopted in which the display apparatus 100 has one or both of the functions of the camera apparatus 200 and the sensor apparatus 300. In addition, the camera apparatus 200 and the sensor apparatus 300 may be structured as a single electronic apparatus.

### Second Embodiment

Next, a second embodiment of the present invention is described. Note that descriptions for sections whose details and operations are the same as those of the above-described first embodiment are omitted by using the same drawings and the reference numerals.

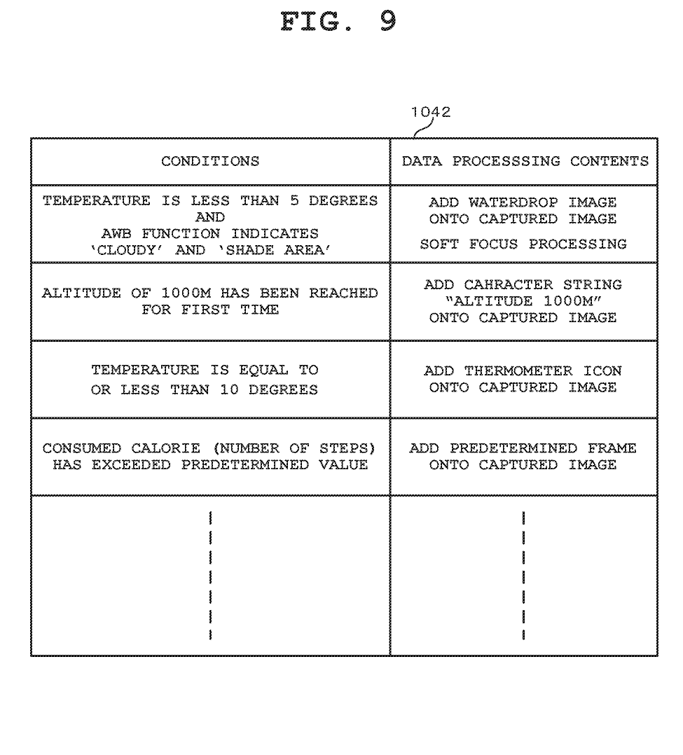

In the second embodiment, the display apparatus 100 has, in the storage section 104, a data processing condition table 1042 such as that shown in FIG. 9. In this data processing condition table, it is defined that, on condition that external environment data (altitude, temperature, atmospheric pressure) in action history data or consumed calorie data calculated based on the user's number-of-steps data has exceeded a predetermined threshold value, a still image file, a moving image file, or a sound file recorded when this condition has been satisfied is processed according to set data processing contents. For example, in the case of FIG. 9, an image judged to have been captured under the condition “TEMPERATURE IS LESS THAN 5 DEGREES AND AWB (AUTOMATIC WHITE BALANCE) FUNCTION INDICATES ‘CLOUDY’ AND ‘SHADE AREA’” is processed to be an image emphasizing a climate condition close to a foggy or misty climate condition, by a waterdrop image being combined therewith and by being subjected to soft focus processing according to the data processing contents. Also, in the case of an image captured when “CONSUMED CALORIE HAS EXCEEDED PREDETERMINED VALUE SET IN ADVANCE”, a decoration or medal image and a predetermined frame are combined therewith according to the data processing contents.

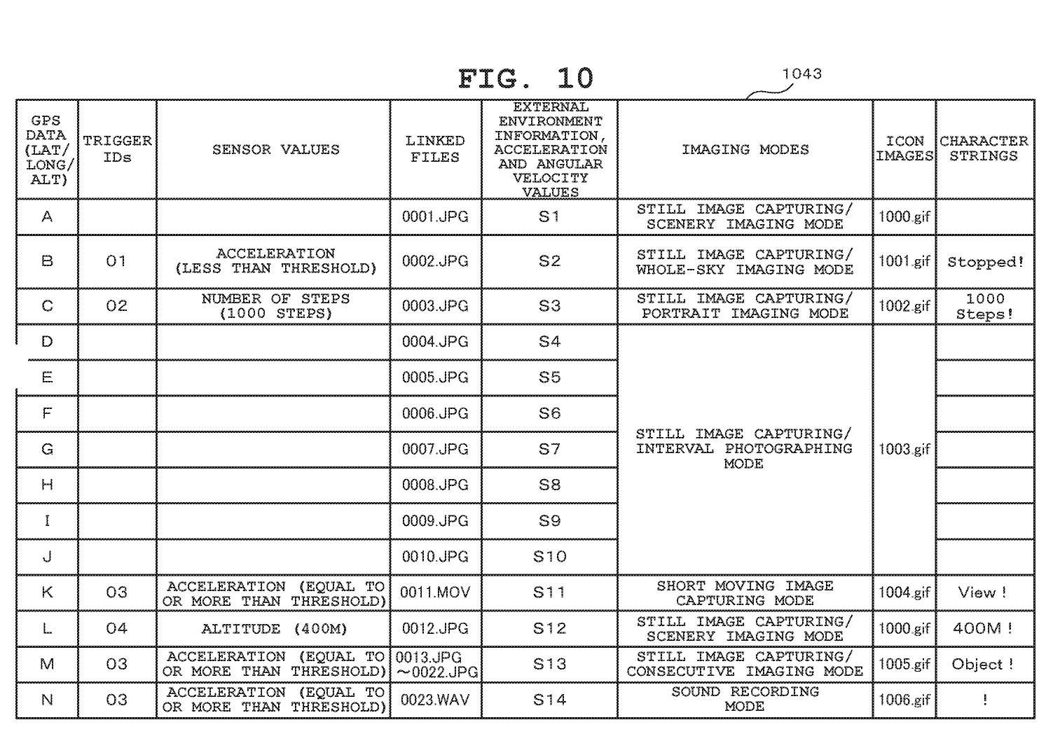

Also, at Step SC108 of FIG. 4, the display apparatus 100 receives the action history data from the sensor apparatus 300 (Step SC107), associates the imaging or sound recording date and time of each file with the GPS data acquired on the same date and time and included in the received action history data, and stores them in a log table 1043 of the storage section 104, as shown in FIG. 10. Here, in the present embodiment, the display apparatus 100 further receives and acquires all aggregated data S1 to S14 of values related to external environment information, accelerations, and angular velocities, and associates them with the respective files and the GPS data based on the acquisition date and time, in the log table 1043.

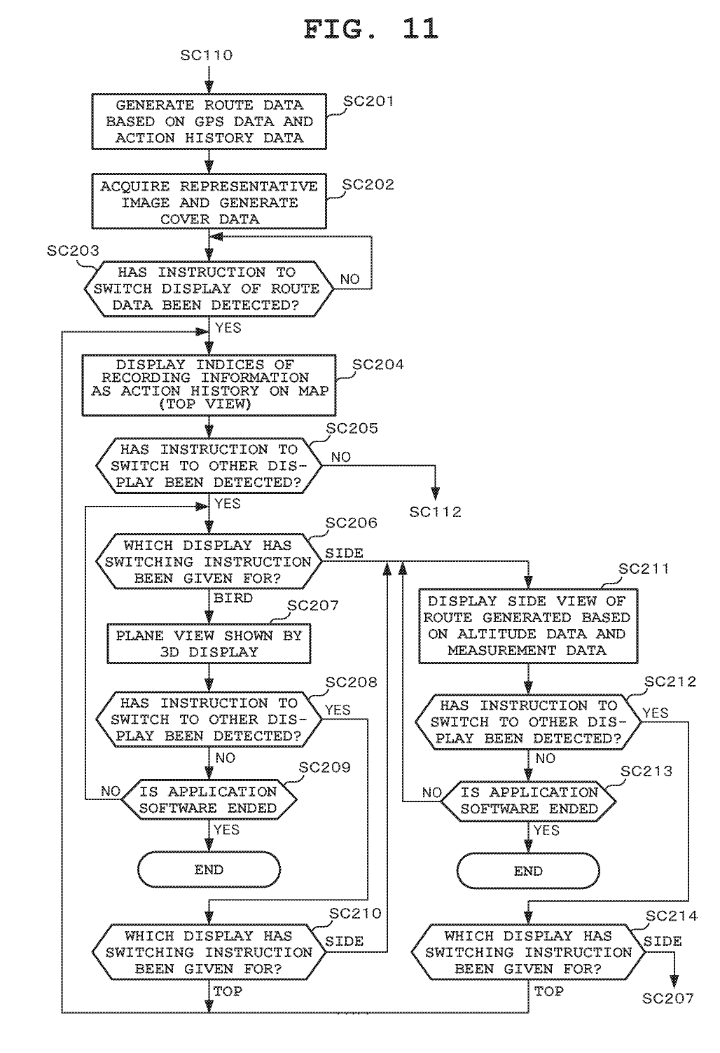

FIG. 11 is a flowchart showing operations in the display apparatus when an image processing program in the second embodiment is activated, which is based on the flowchart of the first embodiment shown in FIG. 5.

When the map data of the area including the points acquired by GPS and corresponding to the plurality of GPS data in the action history data is acquired from the map server 400 in the flow of Step SC110 in FIG. 5, the control section 110 of the display apparatus 100 generates route data based on the GPS data and the action history data (Step SC201). Subsequently, the control section 110 selects a representative image based on the acquired information regarding the recording of the still image files and moving image files or the action history data, acquires the selected image from the camera apparatus 200, and generates cover data based thereon (Step SC202).

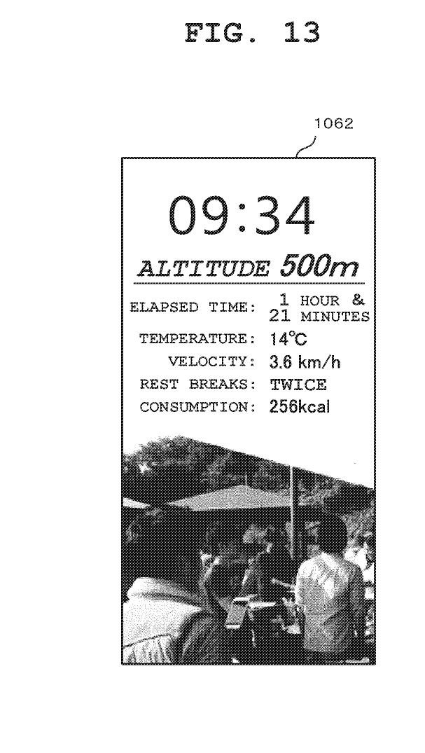

FIG. 13 is a diagram showing an example of cover data to be generated herein. In this drawing, the screen has been divided into upper and lower areas. In the upper display area, the following information is being displayed as information acquired from the GPS data, the action history data, and the like:

The current time “9:34”;

The altitude of an arrival point “ALTITUDE 500 m” calculated from altitude data included in the GPS data and atmospheric pressure data acquired as the external environment data;

The time elapsed from the starting point “ELAPSED TIME: 1 HOUR AND 21 MINUTES”;

The temperature of the arrival point “TEMPERATURE: 14° C.” calculated from temperature data acquired as the external environment data;

The velocity “VELOCITY: 3.6 km/h” calculated based on a movement distance acquired using the elapsed time and the GPS;

The number of times of rest breaks “REST BREAKS: TWICE” when periods of time during which values of the acceleration data, the angular velocity data, and the GPS data acquired while the user is moving have not been changed for a predetermined time or more are taken as rest breaks; and

The consumed calories “CONSUMPTION: 256 kcal” acquired by the value of the number of steps being calculated based on the acceleration data and the angular velocity data acquired while the user is moving.

Also, in the lower area, an image selected and read out from among the plurality of still image files and moving image files recorded for this route is being displayed as a representative image. Note that there are various methods for selecting this representative image. For example, a method may be adopted in which an image showing the landscape of a goal point is selected as a representative image.

At Step SC203, when the cover data is generated and displayed, the control section 110 judges whether an instruction to switch to the route data given by the user performing an external operation has been detected (Step SC203). When judged that no switching instruction has been detected (NO at Step S203), the control section 110 repeatedly waits for this instruction. When judged that a switching instruction has been detected (YES at Step S203), the control section 110 displays a top view 1063 map which is based on the map data acquired from the map server 400 and has indices of recording information (imaging points and sound recording points) indicating that the still image files, the moving image files, and the sound files have been recorded and the user's action history (movement route) recorded in the log table 1043 in FIG. 10 (Step SC204).

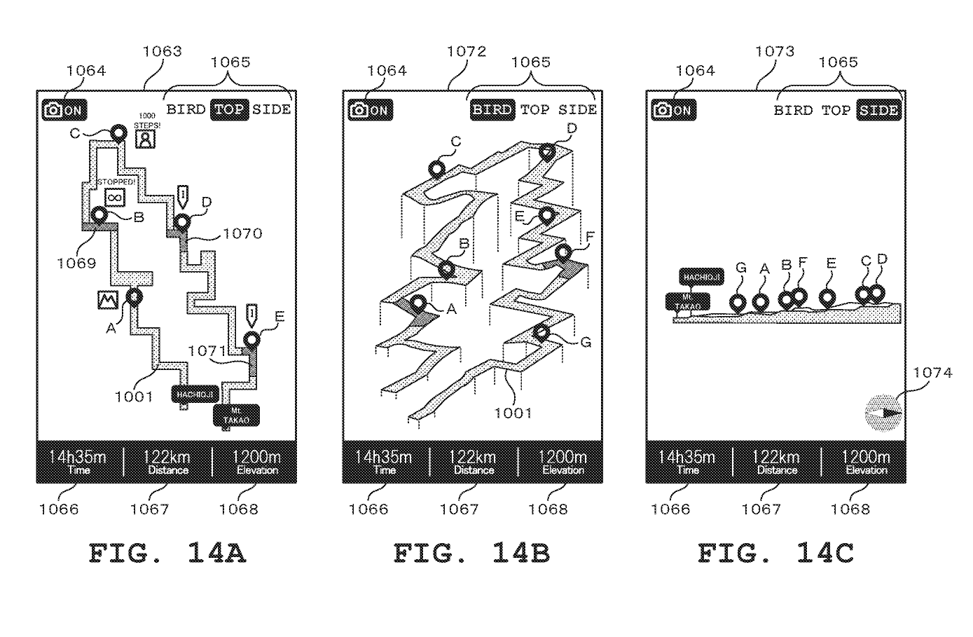

This map display is described using an example shown in FIG. 14A. In the processing of Step SC204, the display apparatus 100 draws, on the top view 1063 map, the user's movement route 1001 based on the GPS data in the action history data acquired by the processing of Step SC107, and displays, on the movement route 1001, points A to E (black circles in the drawing) where the still image files and the moving image files have been recorded.

In addition, the display apparatus 100 displays, on areas near points A to E, icon images (indices) corresponding to modes used at the time of the recording of the images at these points, as information regarding the recording of these images. That is, the display apparatus 100 displays icon images corresponding to imaging modes (including the interval photographing mode) for the captured images (the still image files and the moving image files). In a case where sound data (sound file) is being displayed on the map, an icon image corresponding to the sound recording mode is displayed. Also, the display apparatus 100 displays character strings (such as “STOPPED!”) on areas near points A to C where images have been recorded in response to trigger signals. In this movement route 1001, there are sections 1069 to 1071 whose display color is different from that of the other sections. The display of these sections 1069 to 1071 is differentiated by movement speeds in these sections being calculated based on measured times in the respective sections, movement distances, and values of the acceleration sensor and the angular velocity sensor so that whether the user has walked, run, or used other transportation means can be displayed.

Also, in FIG. 14A, when the user points a replay mode button 1064, the control section 110 controls such that the still image files and the moving image files recorded in this movement route 1001 can be replayed. Display switching buttons 1065 where “BIRD”, “TOP”, and “SIDE” have been displayed are to switch display modes of the movement route 1001. The display modes “BIRD (an abbreviation of BIRD VIEW)”, “TOP (an abbreviation of TOP VIEW)”, and “SIDE (an abbreviation of SIDE VIEW)” are switched by the detection of the user's external operation. In areas below the top view map, the amount of time 1066 spent for this movement route, the movement distance 1067, and the height difference 1068, which have been calculated using the GPS data, the acceleration sensor, the angular velocity sensor, and the external environment data, are displayed. Note that the amount of time 1066 spent therefor, the movement distance 1067, and the height difference 1068 are commonly displayed in each display mode “BIRD”, “TOP”, and “SIDE”

At Step SC205, the control section 101 judges whether an instruction to switch to another display mode (“BIRD” or “SIDE” in this case) has been given by the user performing an external operation on one of the display switching buttons 1065 (Step SC205). When no switching instruction is detected (NO at Step SC205), the control section 101 proceeds to Step SC112 of FIG. 5. Conversely, when a switching instruction is detected (YES at Step SC205), the control section 101 judges whether this instruction is an instruction to switch to the display of “BIRD” or is an instruction to switch to the display of “SIDE” (Step SC206).

When an instruction to switch to “BIRD” is detected, the control section 110 displays a bird view 1072 map which is a plane view map shown by 3D (three-dimensional) display and has indices of the recording information (imaging points and sound recording points) acquired from the top view 1063 and indicating that the still image files, the moving image files, and the sound files have been recorded and the user's action history data (movement route) recorded in the log table 1043 in FIG. 10 (Step SC207). This map display is described using an example shown in FIG. 14B. As shown in FIG. 14B, the display apparatus 100 draws, on the bird view 1072 map, the user's movement route 1001 based on the GPS data in the action history data acquired by the processing of Step SC107, and displays, on the movement route 1001, points A to G (black circles in the drawing) where the still image files and the moving image files have been recorded. Note that, although the icon images corresponding to the imaging modes (including the interval photographing mode) for the captured images (the still image files and the moving image files) are not displayed in this display mode, a configuration where they are displayed may be adopted.

Then, at Step SC208, the control section 101 judges whether an instruction to switch to another display mode has been given by the user performing an external operation on one of the display switching buttons 1065 (Step SC208). When no switching instruction is detected at Step SC208 (NO at Step SC208), the control section 101 judges whether an instruction to end the application software has been detected (Step SC209). When an instruction to end the application software is detected at Step SC209 (YES at Step SC209), the control section 101 ends the processing. Conversely, when no application end instruction is detected at Step SC209 (NO at Step SC209), the control section 101 returns to the processing of Step SC206. At Step SC208, when a switching instruction is detected, the control section 101 judges whether this instruction is an instruction to switch to the display of “SIDE” or is an instruction to switch to the display of “TOP” (Step SC210).

Here, when an instruction to switch to “TOP” is detected, the control section 101 proceeds to Step SC204. On the other hand, when an instruction to switch to “SIDE” is detected, the control section 110 displays, without displaying a map, a side view 1073 having indices of the recording information (imaging points and sound recording points) indicating that the still image files, the moving image files, and the sound files have been recorded and route data acquired based on the altitude data and measurement data (mainly inclination angles) measured by the acceleration sensor and the angular velocity sensor among the user's action history data recorded in the log table 1043 in FIG. 10 (Step SC211).

This display is described using an example shown in FIG. 14C. As shown in FIG. 14B, in the processing of Step SC211, the display apparatus 100 displays, on data briefly showing high and low points on the movement route, points A to G (black circles in the drawing) where the still image files and the moving image files have been recorded. Note that, although the icon images corresponding to the imaging modes (including the interval photographing mode) for the captured images (the still image files and the moving image files) are not displayed in this display mode, a configuration where they are displayed may be adopted.

Then, at Step SC212, the control section 101 judges whether an instruction to switch to another display mode has been given by the user performing an external operation on one of the display switching buttons 1065 (Step SC212). When no switching instruction is detected at Step SC212 (NO at Step SC212), the control section 101 judges whether an instruction to end the application software has been detected (Step SC213). When an instruction to end the application software is detected at Step SC213 (YES at Step SC213), the control section 101 ends the processing. Conversely, when no application end instruction is detected at Step SC213 (NO at Step SC213), the control section 101 returns to the processing of Step SC211. At Step SC212, when a switching instruction is detected (YES at Step SC212), the control section 101 judges whether this instruction is an instruction to switch to the display of “TOP” or is an instruction to switch to the display of “BIRD” (Step SC214). Here, when an instruction to switch to “TOP” is detected, the control section 101 proceeds to Step SC204. On the other hand, when an instruction to switch to “BIRD” is detected, the control section 110 proceeds to Step SC207.

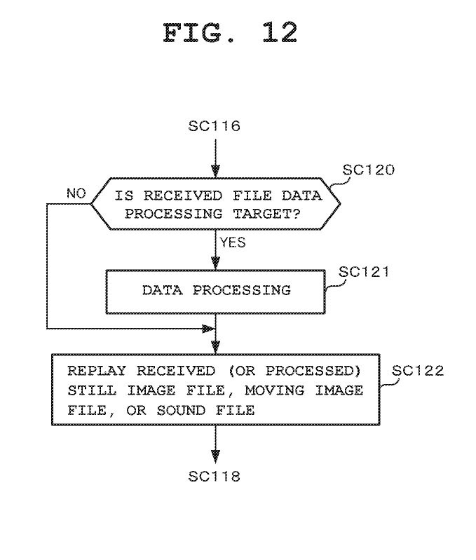

Also, at Step SC116, when a still image file, a moving image file, or a sound file is received from the camera apparatus 200 (Step SC116), the display apparatus 100 acquires external environment data at the time of the acquisition (recording or image capturing) of this file, number-of-steps data at that time which has been calculated from acceleration data and angular velocity data, and consumed calorie data acquired based on the number-of-steps data. Subsequently, the display apparatus 100 judges whether the acquired data satisfies a condition set in the data processing condition table in FIG. 9, and thereby judges whether the corresponding still image file, moving image file, or sound file is subjected to the data processing, as shown in FIG. 12 (Step SC120). When judged that it is a processing target file, (YES at Step SC120), the display apparatus 100 performs the data processing on this target file (Step SC121), and replays a still image, moving image, or sound subjected to the data processing (Step SC122). Note that details of this data processing have already been described in the descriptions of FIG. 9, and therefore are omitted herein. At Step SC120, when judged that it is not a processing target file, (NO at Step SC120), the display apparatus 100 replays a still image, moving image, or sound included in this file.

As described above, the display apparatus 100 of the second embodiment is capable of showing a movement route in various modes. Accordingly, the geographical feature of the user's route can be easily grasped. In addition, by external environment data, action history data, and data processing conditions being associated with one another, received still image files, moving image files, and sound files can be replayed and outputted as files marking the achievement of a specific goal.

In the present embodiment, the display system has been mainly described which is constituted by the display apparatus 100, the camera apparatus 200, and the sensor apparatus 300.

However, a configuration may be adopted in which the display apparatus 100 has one or both of the functions of the camera apparatus 200 and the sensor apparatus 300. In addition, the camera apparatus 200 and the sensor apparatus 300 may be structured as a single electronic apparatus.

While the present invention has been described with reference to the preferred embodiments, it is intended that the invention be not limited by any of the details of the description therein but includes all the embodiments which fall within the scope of the appended claims.

What is claimed is:

1. A display apparatus comprising:
a positional information acquisition section which acquires positional information regarding capturing of an image;
an imaging information acquisition section which acquires predetermined information regarding the capturing of the image;
a generation section which generates an index image based on the predetermined information acquired by the imaging information acquisition section; and
a display section which displays the index image generated by the generation section at a position indicated by the positional information acquired by the positional information acquisition section.

2. The display apparatus according to claim 1, further comprising:
an action information acquisition section which acquires information regarding an action of a person carrying an imaging apparatus that has captured the image,
wherein the display section further displays the information regarding the action acquired by the action information acquisition section and the predetermined information in association with each other.

3. The display apparatus according to claim 2, wherein the information regarding the action includes information regarding plural types of movement manners of the person carrying the imaging apparatus, and
wherein the display section displays the information regarding the plural types of movement manners as the information regarding the action such that the plural types of movement manners are differentiated from one another.

4. The display apparatus according to claim 1, further comprising:
an external environment information acquisition section which acquires information regarding an external environment of an imaging apparatus that has captured the image,
wherein the display section further displays the information regarding the external environment acquired by the external environment information acquisition section.

5. The display apparatus according to claim 1, further comprising:
an instruction detection section which detects an instruction on the predetermined information displayed by the display section; and
a display control section which controls to display, on the display section, the image corresponding to the predetermined information for which the instruction has been detected by the instruction detection section.

6. The display apparatus according to claim 5, further comprising:
an action information acquisition section which acquires information regarding an action of a person carrying an imaging apparatus that has captured the image; and
a first control section which controls to associate the image to be displayed on the display section with the information regarding the action,
wherein the display control section controls to display the image on the display section in a display mode based on the information regarding the action associated by the first control section.

7. The display apparatus according to claim 5, further comprising:
an external environment information acquisition section which acquires information regarding an external environment of an imaging apparatus that has captured the image; and
a second control section which controls to associate the image to be displayed on the display section with the information regarding the external environment,
wherein the display control section controls to display the image on the display section in a display mode based on the information regarding the external environment associated by the second control section.

8. The display apparatus according to claim 6, wherein the display control section controls to perform predetermined processing on the image to be displayed or to combine another image with the image to be displayed.

9. The display apparatus according to claim 1, further comprising:
a communication section which communicates with an external device,
wherein at least one of the image, the positional information, and the predetermined information is received by the communication section.

10. The display apparatus according to claim 1, wherein the predetermined information is information regarding an imaging mode used to capture the image.

11. The display apparatus according to claim 1, wherein the capturing of the image includes image capturing that is performed with satisfaction of a predetermined condition as a trigger.

12. A display method comprising:
a positional information acquisition step of acquiring positional information regarding capturing of an image;
an imaging information acquisition step of acquiring predetermined information regarding the capturing of the image;
a generation step of generating an index image based on the predetermined information acquired in the imaging information acquisition step; and
a display step of displaying the index image generated in the generation step at a position indicated by the positional information acquired in the positional information acquisition step.

13. A non-transitory computer-readable storage medium having stored thereon a program that is executable by a computer to actualize functions comprising:
positional information acquisition processing for acquiring positional information regarding capturing of an image;
imaging information acquisition processing for acquiring predetermined information regarding the capturing of the image;
generation processing for generating an index image based on the predetermined information acquired in the imaging information acquisition processing; and
display processing for displaying the index image generated in the generation processing at a position indicated by the positional information acquired in the positional information acquisition processing.

14. A display system comprising:
a display apparatus;
a positional information recording apparatus which sequentially records positional information of a moving person; and
an imaging apparatus which is carried by the person,
wherein the display apparatus comprises:
a positional information acquisition section which acquires the positional information from the positional information recording apparatus;
an imaging information acquisition section which acquires, from the imaging apparatus, predetermined information regarding capturing of an image recorded in the imaging apparatus;
a generation section which generates an index image based on the predetermined information acquired by the imaging information acquisition section; and
a display control section which controls to display the index image generated by the generation section at a position indicated by the positional information acquired by the positional information acquisition section.
